(19) United States
(12) Patent Application Publication
(10) Pub. No.: US 2026/0094242 A1
(43) Pub. Date: Apr. 2, 2026

(54) CAMERA OF A MOBILE DEVICE FOR GENERATING A TELEPHOTO IMAGE REPRESENTATION

(71) Applicant: Carl Zeiss AG, Oberkochen (DE)

(72) Inventors: Gerald Franz, Backnang (DE); Lars Omlor, Nuernberg (DE); Alen Philip, Aalen (DE)

(21) Appl. No.: 19/321,282

(22) Filed: Sep. 7, 2025

(30) Foreign Application Priority Data
Sep. 27, 2024 (DE) 10 2024 128 121.9

(51) Int. Cl. G06T 5/50; G02B 13/10; G06T 5/10; G06T 5/60; G06T 5/70; G06T 5/80; H04N 23/50; H04N 23/81

(52) U.S. Cl. CPC G06T 5/50; G02B 13/10; G06T 5/10; G06T 5/60; G06T 5/70; G06T 5/80; H04N 23/50; H04N 23/81; G06T 2207/20084

(57) ABSTRACT

A camera of a mobile device includes at least two entrance openings and at least two image sensors. A first entrance opening is assigned to a first image sensor via a first imaging path and a second entrance opening is assigned to a second image sensor via a second imaging path. Each of the entrance openings has a light entrance surface with a longitudinal direction and a transverse direction running perpendicular thereto. The length of the entrance opening in the longitudinal direction is at least 1.2 times larger than the width of the entrance opening in the transverse direction. The first imaging path and the second imaging path each include anamorphic optics. In addition, a mobile device including the camera, and a method for generating an image representation with the camera are provided.

### CROSS REFERENCE TO RELATED APPLICATIONS

This application claims priority to German patent application DE 10 2024 128 121.9, filed Sep. 27, 2024, the entire content of which is incorporated herein by reference.

### TECHNICAL FIELD

The present disclosure relates to a camera of a mobile device, a mobile device, and a method for generating an image representation, in particular a telephoto image representation, with a camera.

### BACKGROUND

The possibility of recording high-quality telephoto image representations, i.e., enlarged image representations of a more distant object, with cameras integrated into mobile devices, is on the one hand desirable from the point of view of consumers, but on the other hand poses a considerable technical challenge for manufacturers. Cameras for recording enlarged image representations require lenses designed for this purpose, especially telephoto lenses, as well as a large stop opening or aperture. In connection with cameras for mobile devices that are usually very flat, in particular cellular phones, the size of the aperture or stop opening is greatly restricted in view of the available installation space, with the result that the possible entrance opening is limited even when there is a folded beam path or imaging path. In the case of a square entrance opening, a mirror required for folding the beam path, starting from a specific size of the entrance opening and thus also of the mirror in relation to its height, no longer fits into a housing of a conventional mobile device.

Rectangular entrance openings may increase the effective size or area of the entrance opening, but the larger aspect ratio, which then in the case of a so-called slit aperture, i.e., a rectangular entrance opening with a side ratio of at least 3:2, is for example 3:1 or larger, leads to the occurrence of diffraction-governed artefacts. Furthermore, a larger field of view (FOV) associated with a larger entrance opening implies a larger image sensor, which under certain circumstances likewise does not fit into a mobile device.

At the present time, only telephoto cameras for mobile devices having a long focal length with a function corresponding to that of a 35 mm camera having a focal length of more than 200 mm, for example, are known, the images from which yield a comparatively small field of view and are of limited quality owing to diffraction-governed artefacts.

The document Carles, G. and Harvey, A. R.: Multi-aperture imaging for flat cameras, in: Optics letters, Vol. 45, No. 22, pages 6182-6185, from 11.15.2020, describes flat cameras having one or more rectangular entrance openings, a plurality of image data transformed with Fourier transformation being combined to form a common image data set and being inverse transformed.

### SUMMARY

Against the described background, it is an object of the present disclosure to provide an advantageous camera of a mobile device, an advantageous mobile device and an advantageous method for generating an image representation, in particular a telephoto image representation, with a camera. These objects are achieved by camera of a mobile device, a mobile device, and a method for generating an image representation with a camera, as described herein.

The camera according to an aspect of the disclosure of a mobile device includes at least two entrance openings, in other words at least two stops or apertures or light entrance apertures, and at least two image sensors. In this case, a first entrance opening is assigned to a first image sensor via a first imaging path, and a second entrance opening is assigned to a second image sensor via a second imaging path. An imaging path defines the beam path of a light beam from an entrance stop or entrance opening as far as an image plane or an image sensor. The respective imaging path thus defines the respective beam path in the camera. In other words, light is guided from the first entrance opening to the first image sensor and light is guided from the second entrance opening to the second image sensor. For telephoto cameras in the mobile devices that are usually very flat, in particular cellular phones, the entrance stop or entrance opening generally coincides with the entrance pupil owing to the limited installation space. However, this does not necessarily need to be the case, that is to say that an internal aperture or stop may also be present. All that is crucial for the present disclosure is that the entrance pupil of the entire optical path (including a deflection prism and housing parts) is different in two mutually perpendicular directions, that is to say that there is differing quality (blur) of the image representation in two mutually perpendicular directions.

The at least two entrance openings each have a light entrance surface having a longitudinal direction, e.g., a longitudinal axis of a local coordinate system related to the entrance opening, and a transverse direction running perpendicularly thereto, e.g., a transverse axis of a local coordinate system related to the entrance opening. Here the length of the entrance opening in the longitudinal direction, i.e., the dimension of the entrance opening in the longitudinal direction, is in each case at least a factor of 1.2, typically a factor of 2, larger than the width of the entrance opening in the transverse direction, i.e., the dimension of the entrance opening in the transverse direction. The stop openings here do not need to be rectangular, that is to say that elliptic or differently shaped stop openings are also conceivable.

The first imaging path, i.e., the beam path between the first entrance opening and the first image sensor, and the second imaging path, i.e., the beam path between the second entrance opening and the second image sensor, typically each include an anamorphic optical unit, or in other words at least one anamorphic lens. The anamorphic optical unit can have at least one cylindrical optical element, e.g., at least one cylindrical lens or at least one cylindrical mirror. The cylindrical optical element can be configured in a refractive or diffractive fashion.

The camera according to the disclosure, which can also be a camera system or a camera arrangement, makes it possible to capture image data for generating high-quality telephoto image representations with very little installation space. In this case, the geometric configuration of the entrance openings, i.e., their slit-like shape, allows the integration of at least two folded beam paths into a mobile device, e.g., a cellular phone. By virtue of a combination, of the image data captured by the at least two image sensors, it is possible to generate virtually the entire image information of a telephoto image representation which, in accordance with the prior art, requires an entrance opening and an image sensor each of a size which cannot be integrated into a cellular phone. The use of an anamorphic optical unit makes possible an enlarged field of view in comparison with previously known solutions, even in the case of large magnifications and image sizes. Narrower image sensors can thus be used, without this resulting in a reduced field of view (FOV). Furthermore, owing to the Fourier transformations, only short computation time and low computing power are required for generating a high-quality telephoto image representation.

The present disclosure affords a camera system having a very effective entrance opening which makes it possible to integrate lenses having a long focal length and a large FOV into a mobile device, e.g., a cellular phone. Furthermore, the camera according to an aspect of the disclosure affords a very high effective aperture, e.g., an f-number of 1.4 (f-number F=focal length f/aperture diameter D), which can be integrated into flat housings of mobile devices, in particular in order to realize long focal lengths, e.g., f=21 mm.

In an exemplary embodiment of the disclosure, the first entrance opening and the second entrance opening are arranged geometrically with respect to one another in such a way that the longitudinal direction of the first entrance opening and the longitudinal direction of the second entrance opening form an angle of between 70 degrees and 110 degrees, in particular between 80 degrees and 100 degrees, typically 90 degrees. The perpendicular or almost perpendicular arrangement of the longitudinal directions of the entrance openings with respect to one another has the advantage that a large field of view can be attained. Moreover, virtually the entire image information of a comparable telephoto image representation can be reconstructed, the comparable telephoto image representation being recorded with a square image sensor and a square entrance opening having a side length corresponding to the length of the two entrance openings used in the present case in the longitudinal direction. The entrance openings can be arranged in a T-shaped or L-shaped manner with respect to one another.

Typically, the camera includes an evaluation device or image processing device. The evaluation device or image processing device is configured to receive image data captured by the at least two image sensors, e.g., the first and second image sensors, to transform the received image data from the individual image sensors with Fourier transformation, to generate a common data set from the transformed image data, i.e., to combine the transformed image data to form a common data set, and to inverse transform the generated common data set with Fourier transformation. In this way, with a camera taking up only a very small installation space, it is possible to generate high-quality telephoto image representations with a magnification which cannot normally be realized in the available installation space.

In particular, the image processing device can be configured, for the purpose of generating the common data set, to partly mask the transformed image data from the individual image sensors such that the transformed image data mutually supplement and/or partly overlap one another, e.g., are added. In addition or as an alternative thereto, the image processing device can be configured, for the purpose of generating the common data set, to select, e.g., cut out, the transformed image data from the individual image sensors in such a way that the transformed image data mutually supplement and/or partly overlap one another, e.g., are added. These exemplary embodiments make possible a virtually complete image reconstruction for generating a high-quality telephoto image representation.

In a further exemplary embodiment of the disclosure, the image processing device can be configured to correct artefacts and/or aberrations in an image representation generated with the inverse-transformed image data or in an image file and/or for supplementing image data in Fourier spectral ranges not captured by the image sensors, e.g., pertaining to a blurred image representation of object structures oriented obliquely with respect to the two longitudinal directions of the stops or the entrance opening. The quality of the generated telephoto image representation can be improved as a result. Typically, the image processing device can be configured to correct artefacts and/or aberrations and/or for supplementing image data in an image representation generated with the inverse-transformed image data, with a neural network. The quality of the generated telephoto image representation can be further improved as a result.

The image processing device can be configured for pixel binning. This makes it possible to realize a zoom function and/or to reduce the magnification and/or to enlarge the field of view (FOV).

Optionally, the first imaging path, in particular the beam path between the first entrance opening and the first image sensor, and/or the second imaging path, in particular the beam path between the second entrance opening and the second image sensor, can include a telephoto optical unit. In principle, the beam paths, i.e., the beam path between the first entrance opening and the first image sensor and/or the beam path between the second entrance opening and the second image sensor, can be configured in a folded fashion. This reduces the required installation space.

In a further exemplary embodiment, the first imaging path and/or the second imaging path can each include an optical unit, each of which per se is configured in such a way that the parallax error resulting from the positioning of the entrance openings, or in other words resulting from the different installation locations of the imaging paths, is reduced, in particular compensated for, for objects at a distance which is less than 100 times the smaller of the two focal lengths of the anamorphic system.

Specifically, the parallax error can be compensated for as follows. The two imaging paths for generating an image of the same object can be guided separately in mutually independent “off-axis” systems and led to individual image sensors. The image data captured via the individual imaging paths can thus be separated, e.g., by elements for beam deflection, such as in particular mirrors or prisms or other suitable refractive or diffractive optical elements. Further optical elements, e.g., mirrors or prisms for folding the beam path, can be arranged between the respective optical element used for beam deflection and the respective image sensor. The images or image data separated in this way have different diffraction effects and can be processed individually. In particular, the image data can be stretched or compressed independently of one another in order to adapt them to one another.

The camera according to an aspect of the disclosure can have a field of view (FOV) of at least 10 degrees, for example a square FOV of 16 degrees by 16 degrees (16°×16°). This constitutes a significant improvement in comparison with the prior art cited in the introduction, which mentions only an achieved FOV of 6.1 degrees by 3.8 degrees for the same magnification. In particular, a square FOV can be realized according to an aspect of the disclosure with, e.g., two rectangular entrance openings and two rectangular image sensors.

The at least two entrance openings and/or the at least two image sensors can have a rectangular cross-sectional area. This is advantageous in terms of production engineering and makes possible a maximum opening area under predefined geometric constraints. A rectangular cross-sectional area having rounded corners or some other slit-like shaping is likewise possible. The at least two entrance openings can have cross-sectional areas shaped geometrically differently than one another. These do not have to be rectangular.

The mobile device according to an aspect of the disclosure includes a camera according to an aspect of the disclosure as already described. The mobile device according to an aspect of the disclosure has the already described features and advantages of the camera. The mobile device according to an aspect of the disclosure can be a cellular phone, tablet, notebook, smartwatch, netbook, etc.

The method according to an aspect of the disclosure for generating an image representation, in particular a telephoto image representation or enlarged image representation, with an above-described camera according to an aspect of the disclosure includes the following steps: capturing image data with the at least two image sensors, transforming the captured image data with Fourier transformation, generating a common data set from the transformed image data, i.e., the image data transformed with Fourier transformation, and inverse transforming the generated common data set with Fourier transformation. Typically, an image representation, in particular a telephoto image representation, can be generated from the inverse-transformed image data. The method according to an aspect of the disclosure has the advantages already described in connection with the camera according to an aspect of the disclosure.

Generating a common data set from the transformed image data can include combining and/or masking and/or cutting out and/or selecting and/or superimposing specific data or data regions. This eliminates imaging aberrations and improves the imaging quality.

Artefacts and/or aberrations in the generated image representation can be corrected and/or items of image information not captured in the frequency domain can be supplemented. The correction and/or supplementation can be effected with neural networks. Conventional, generally available neural networks can be used in this case. Artefacts and/or aberrations can occur in the generated image representation in particular in the regions in which image data were added to one another, superimposed on one another or supplemented. In mutually overlapping image regions, the frequencies can be weighted and/or normalized. Furthermore, frequency edges or frequency jumps can be compensated for or avoided. This can be done by smoothing or soft-focus, e.g., by replacing a step function at the affected points with a rounded step function.

Furthermore, items of image information not captured in the frequency domain can lead to artefacts in the reconstructed image. These artefacts are either missing features, i.e., structures having frequencies that fall principally within the missing regions, or so-called ringing artefacts, which look like repeating edges. Such artefacts can be reduced with trained neural networks. The image captured by the at least two rectangular, typically slit-like, image sensors, or the image data, is/are used as input into such a neural network. The complete image or the complete image representation without the missing frequency components or frequency ranges is made available as output. The neural network learns to detect most ring artefacts. Diffusion models or GAN models (GAN-Generative Adversarial Network) can be used in this context. Such networks can also replace or supplement missing image regions, although the image content does not necessarily correspond to the object to be imaged, i.e., the original object. In addition or as an alternative to the use of neural networks as an approach for reducing or correcting artefacts, the reduction of artefacts can also be formulated as a traditional deconvolution problem and solved with iterative optimization methods.

### BRIEF DESCRIPTION OF THE DRAWINGS

The disclosure will now be described with reference to the drawings wherein:

FIG. 1 schematically shows a camera of a mobile device in a plan view according to an exemplary embodiment of the disclosure,

FIG. 2 schematically shows a camera of a mobile device in the form of a block diagram according to an exemplary embodiment of the disclosure,

FIG. 3 schematically shows the simulated beam path of one of the optical paths in a perspective view,

FIG. 4 schematically shows the beam path shown in FIG. 3 in a side view,

FIG. 5 schematically shows the step of capturing image data,

FIG. 6 schematically shows the captured image data transformed with Fourier transformation,

FIG. 7 schematically shows the step of masking specific image data regions,

FIG. 8 schematically shows the steps of generating a common data set and inverse transforming,

FIG. 9 schematically shows the effect of diffraction effects on the captured image data and the reduction thereof, and

FIG. 10 schematically shows the effect of the aspect ratio on the formation of artefacts.

### DESCRIPTION OF EXEMPLARY EMBODIMENTS

The disclosure is explained in larger detail below on the basis of exemplary embodiments with reference to the accompanying figures. Although the disclosure is more specifically illustrated and described in detail with the exemplary embodiments, nevertheless the disclosure is not restricted by the exemplary embodiments disclosed, and other variations can be derived therefrom by a person skilled in the art, without departing from the scope of protection of the disclosure.

The figures are not necessarily accurate in every detail and to scale and can be presented in enlarged or reduced form for the purpose of better clarity. For this reason, functional details disclosed here should not be understood to be limiting, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used. For example, if a structure is described containing the components A, B and/or C, the structure can contain A alone; B alone; C alone; A and B in combination; A and C in combination; B and C in combination; or A, B, and C in combination.

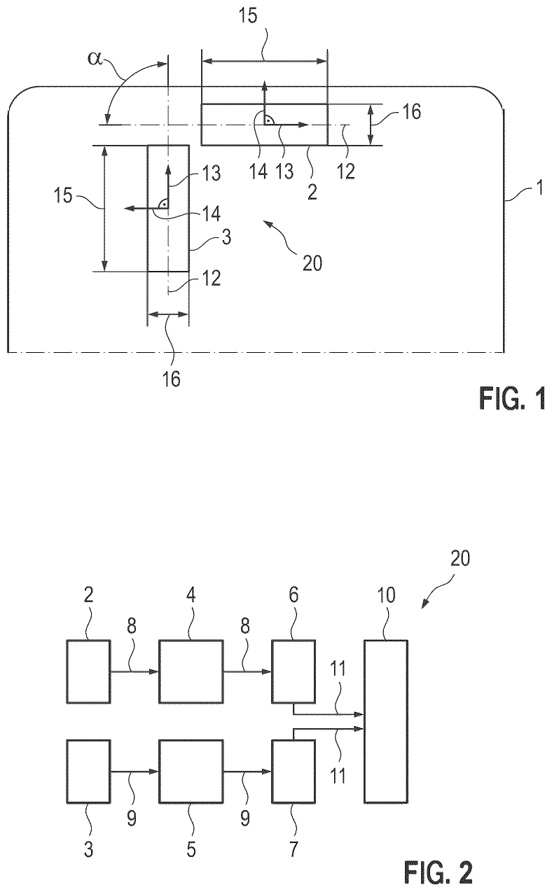

FIG. 1 schematically shows a camera 20 of a mobile device 1 in a plan view according to an exemplary embodiment of the disclosure. The mobile device 1 can be a cellular phone, for example. The camera 20 shown includes a first entrance opening 2 and a second entrance opening 3. In the exemplary embodiment shown in FIG. 1, the entrance openings 2 and 3 are configured identically and each have a longitudinal direction 13 and a transverse direction 14 running perpendicularly thereto. The length 15 in the longitudinal direction 13 of the entrance openings 2 and 3 is in each case at least by a factor of 1.2, typically by at least a factor of 2, larger than the width 16 in the transverse direction 14.

The longitudinal directions 13 or center lines 12 running in the longitudinal direction 13 of the entrance openings 2 and 3 form an angle α which is typically between 70 degrees and 110 degrees and is 90 degrees in the exemplary embodiment shown.

In the exemplary embodiment shown in FIG. 1, the entrance openings 2 and 3 are arranged next to one another and offset with respect to one another. As an alternative thereto, a T-shaped arrangement or a non-offset L-shaped arrangement is also possible.

FIG. 2 schematically shows a camera 20 of a mobile device 1 in the form of a block diagram. The camera 20 shown includes at least two image sensors 6 and 7, the first entrance opening 2 being assigned to a first image sensor 6 via a first imaging path 8 and a second entrance opening 3 being assigned to a second image sensor 7 via a second imaging path 9. The first imaging path 8 and the second imaging path 9 each include an anamorphic optical unit 4 and 5, respectively, and a telephoto optical unit (not explicitly shown).

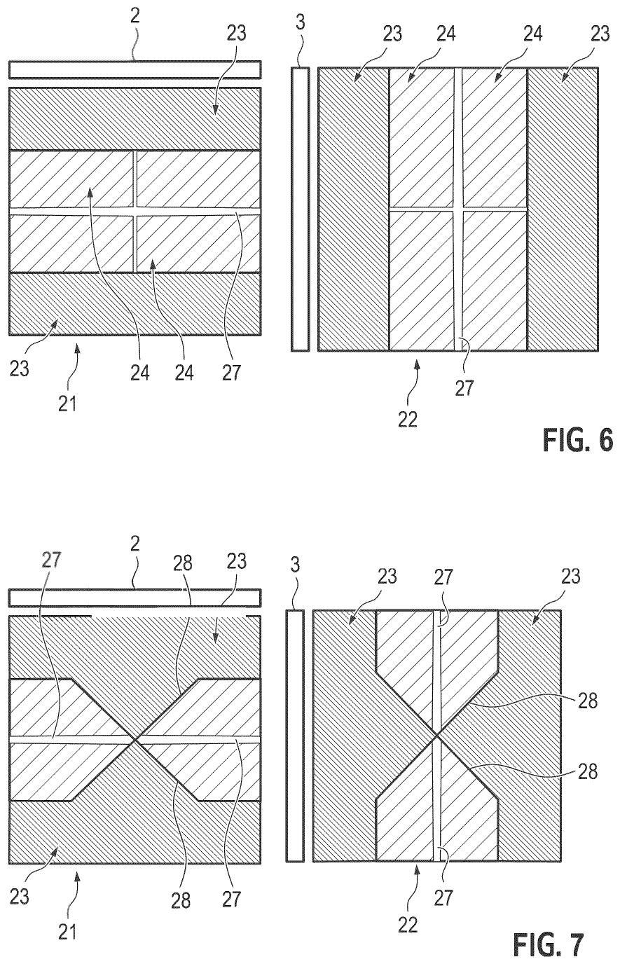

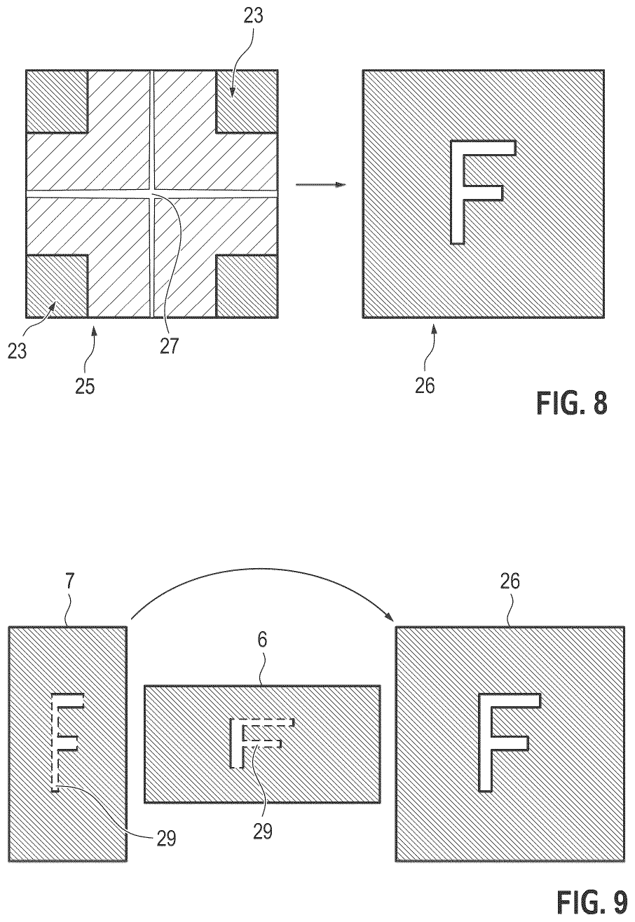

Optionally, the camera 20 includes an image processing device 10 configured for receiving image data captured with the aid of the image sensors 6 and 7, and for processing said image data. The data transfer is identified by arrows with the reference sign 11. The image processing device 10 is configured to transform the received image data from the image sensors 2, 3 with Fourier transformation (see FIGS. 5 and 6), to generate a common data set from the transformed image data (see FIG. 7), i.e., to combine the transformed image data to form a common data set, and to inverse transform the generated common data set with Fourier transformation (see FIG. 8). Neural networks, as already described above, can be used for correcting artefacts and/or aberrations.

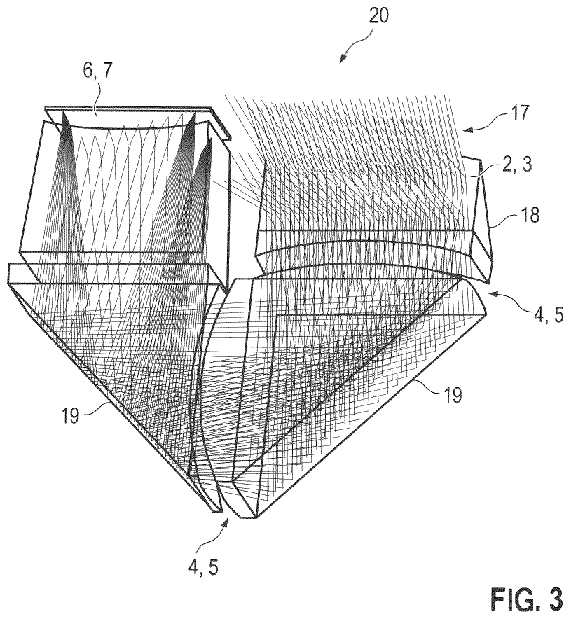

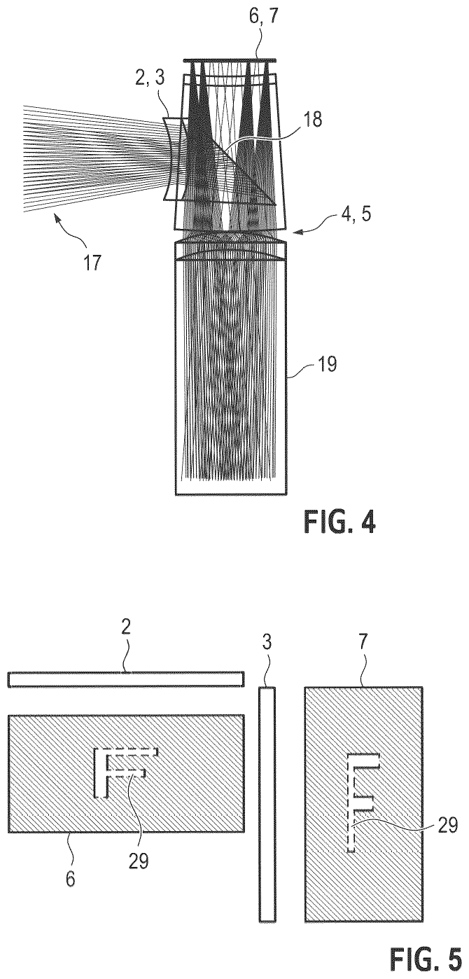

FIG. 3 schematically shows the beam path 17 of one of the optical paths 8, 9 of the camera 20 in a perspective view, this beam path having been simulated using the software Zemax. FIG. 4 schematically shows the beam path 17 shown in FIG. 3 in a side view. Light 17 entering the camera 20 through the rectangular entrance opening 2, 3 is reflected into a plane of the mobile device 20 with a mirror 18 and is subsequently guided in this plane to the rectangular image sensor 6, 7. In the exemplary embodiment shown, the image sensor 6, 7 is arranged perpendicularly to the plane of the mobile device 20, i.e., vertically. As an alternative thereto, an arrangement of the image sensor 6, 7 in the plane of the mobile device 20, i.e., horizontally, is also possible.

An anamorphic optical unit 4, 5 is arranged in the beam path 17 between the entrance opening 2, 3 or the mirror 18 and the image sensor 6, 7. With the anamorphic optical unit 4, 5, the image or the image representation is distorted and the field of view or the FOV is enlarged in this way. In the exemplary embodiment shown in FIGS. 3 and 4, further optical elements, for example prisms and/or mirrors 19, are additionally arranged in the beam path, and bring about a folding of the beam path 17.

In principle, the telephoto lenses necessary for generating a telephoto image representation, or a corresponding telephoto optical unit, require(s) a large entrance opening. On account of the limited installation space in mobile devices, such as cellular phones, for example, large entrance openings cannot be realized even when there is a folded beam path, in particular since the height of the mirror 18 necessary for folding the beam path is limited by the thickness or depth of the mobile device. This holds true particularly in the case of entrance openings configured in square fashion and image sensors configured in square fashion. A rectangular configuration of the entrance opening makes it possible at least to increase the effective size of the entrance opening. However, diffraction-governed artefacts occur in the case of relatively large aspect ratios, in particular larger than 3:2.

In the exemplary embodiment shown, an aspect ratio of 3:1 is used for the two entrance openings 3 and 4 and the two image sensors 6 and 7. The anamorphic optical unit 4, 5 additionally used can bring about a stretching of the image representation of 2:1, for example, whereby the height of the respective image sensor 6, 7 can be halved in comparison with a square configuration (for example from 10×10 mm to 10×5 mm) by virtue of the image representation or the image being compressed in the diffraction direction. Both measures, i.e., firstly the increase of the aspect ratio and secondly the use of an anamorphic design, make it possible to integrate a telephoto system having a small f-number and a large FOV into a mobile device, for example a cellular phone.

A method for generating an enlarged image representation, i.e., a telephoto image representation, with a camera, for example a camera described with reference to FIGS. 1 to 4, is explained in larger detail below with reference to FIGS. 5 to 10. In this case, a simulation on the basis of a paraxial system with two entrance openings 2, 3 each having an aspect ratio of 15:1 is used for the sake of better elucidation.

In a first step, shown schematically in FIG. 5, image data, of the capital letter “F” in the present case, are captured with the two image sensors 6, 7. In this case, depending on the orientation of the entrance openings 2 and 3, a blur 29 (not able to be depicted well in the figures) occurs in a diffraction-governed manner. In addition, the image representations are compressed anamorphically in the diffraction direction.

Afterward, in a second step, the captured image data are transformed with Fourier transformation. This is shown schematically in FIG. 6. The transformed image data (Fourier spectrum) depicted schematically are identified by the reference signs 21 and 22. The Fourier spectrum has high intensities in the regions 27. In regard to a square Fourier spectrum of an imaginary square image sensor, regions for which no image information has been captured are identified by the reference signs 23. The arrows 24 identify regions in which contributions of higher spatial frequencies are lost depending on the orientation of the entrance openings 2 and 3.

In a further step, shown schematically in FIG. 7, the transformed image data 21 and 22 are masked and/or partial regions thereof are cut out. Afterward, the transformed and masked image data 21 and 22 shown in FIG. 7 are combined to form a common data set 25, the regions 23 with diffraction-governed loss of information being ignored or suppressed. This step is shown schematically on the left in FIG. 8. In practice, the masking can also be dispensed with and the relevant regions are directly combined. Furthermore, individual image data regions at the edges 28 from the different image data sets 21 and 22 can be made to overlap one another or superimposed on one another. As a result, visible transitions can be avoided, and the image quality overall can be improved.

In a further step, shown in FIG. 8, the generated common data set 25 is inverse transformed with Fourier transformation. The result is the telephoto image representation-shown on the right in FIG. 8—of the capital letter “F” recorded with the camera 20. Advantageously, it is possible to correct artefacts and/or aberrations in the generated image representation 26 and/or to supplement missing regions 23 in the corners (see FIG. 8, on the left) in the generated image representation 26, for example with neural networks. In addition, the regions at which the transformed image data 21 and 22 were combined can be smoothed and/or corrected in regard to image aberrations, e.g., with rounded step functions.

FIG. 9 illustrates in summary the effect of diffraction effects at the entrance openings on the image data captured with the image sensors 6 and 7, and also the significant reduction thereof in the image representation 26 generated according to the disclosure.

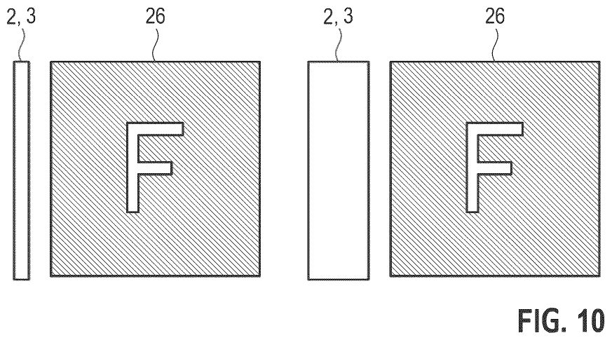

FIG. 10 shows the effect of the aspect ratio of 15:1 of an entrance opening 2, 3 in comparison with an entrance opening 2, 3 having an aspect ratio of 3:1. The remaining artefacts are significantly reduced in the case of an aspect ratio of 3:1.

### LIST OF REFERENCE NUMERALS

1 mobile device
2 entrance opening
3 entrance opening
4 anamorphic optical unit
5 anamorphic optical unit
6 image sensor
7 image sensor
8 imaging path
9 imaging path
10 image processing device
11 data transfer
12 center line
13 longitudinal direction
14 transverse direction
15 length
16 width
17 beam path
18 mirror
19 prism/mirror
20 camera
21 transformed image data
22 transformed image data
23 regions with diffraction-governed loss of information
24 regions with missing higher spatial frequencies
25 common data set
26 image representation generated according to the disclosure
27 region with high intensities
28 image data regions for overlap
29 blur
α angle

What is claimed is:

1. A camera of a mobile device, the camera comprising:
at least two entrance openings; and
at least two image sensors, a first entrance opening of the at least two entrance openings being assigned to a first image sensor of the at least two image sensors via a first imaging path and a second entrance opening of the at least two entrance openings being assigned to a second image sensor of the at least two image sensors via a second imaging path,
wherein:
each of the at least two entrance openings has a light entrance surface with a longitudinal direction and a transverse direction running perpendicularly to the longitudinal direction,
a length of each of the at least two entrance openings in the longitudinal direction is at least by a factor of 1.2 larger than a width of each of the at least two entrance openings in the transverse direction, and
each of the first imaging path and the second imaging path includes an anamorphic optical unit which form an anamorphic system.

2. The camera as claimed in claim 1, wherein the first entrance opening and the second entrance opening are arranged geometrically with respect to one another such that the longitudinal direction of the first entrance opening and the longitudinal direction of the second entrance opening form an angle (α) of between 70 degrees and 110 degrees.

3. The camera as claimed in claim 1, wherein the camera includes an image processing device configured to:
receive image data captured by the at least two image sensors,
generate transformed image data by transforming the image data received from the at least two image sensors with Fourier transformation,
generate a common data set from the image data after transforming the image data, and
generate inverse-transformed image data by inverse transforming the common data set with Fourier transformation.

4. The camera as claimed in claim 3, wherein, to generate the common data set, the image processing device is further configured to:
partly mask the transformed image data from the at least two image sensors such that the transformed image data mutually supplement and/or partly overlap one another, and/or
select transformed image data partial regions such that the transformed image data mutually supplement and/or partly overlap one another.

5. The camera as claimed in claim 3, wherein the image processing device is further configured to:
correct artefacts and/or aberrations in an image representation generated with the inverse-transformed image data, and/or
supplement image data in Fourier spectral ranges not captured by the at least two image sensors.

6. The camera as claimed in claim 5, wherein the image processing device is further configured to correct artefacts and/or aberrations, and/or supplement the image data in the image representation generated with the inverse-transformed image data, with a neural network.

7. The camera as claimed in claim 3, wherein the image processing device is configured to perform pixel binning.

8. The camera as claimed in claim 1, further comprising a telephoto optical unit arranged in each of the first imaging path and/or the second imaging path.

9. The camera as claimed in claim 1, wherein a first anamorphic optical unit is arranged in the first imaging path and has a first focal length,
wherein a second anamorphic optical unit is arranged in the second imaging path and has a second focal length,
wherein the first and second anamorphic optical units are configured such that a parallax error resulting from a positioning of the first and second entrance openings is reduced for objects at a distance which is less than 100 times the smaller of the first and second focal lengths of the anamorphic system.

10. The camera as claimed claim 1, wherein the camera has a field of view of at least 10 degrees.

11. The camera as claimed in claim 1, wherein the at least two entrance openings and/or the at least two image sensors have a rectangular cross-sectional area, and/or
wherein the at least two entrance openings have geometrically differing cross-sectional areas.

12. The mobile device comprising the camera as claimed in claim 1.

13. The mobile device as claimed in claim 12, wherein the mobile device is a cellular phone, a tablet, a notebook, a smartwatch, or a netbook.

14. A method for generating an image representation with the camera as claimed in claim 1, the method comprising:
capturing image data with the at least two image sensors;
generating transformed image data by transforming the image data with Fourier transformation;
generating a common data set from the transformed image data; and
inverse transforming the common data set with the Fourier transformation.

15. The method as claimed in claim 14, wherein generating a common data set from the transformed image data comprises at least one of combining, masking, cutting out, selecting, and superimposing specific image data regions.

16. The method as claimed in claim 14, further comprising:
correcting artefacts and/or aberrations in the image representation, and/or
supplementing items of image information not captured in a frequency domain in the image representation.
